(19) United States
(12) Patent Application Publication
(10) Pub. No.: US 2024/0018999 A1
(43) Pub. Date: Jan. 18, 2024

(54) THRUST ROLLER BEARING

(71) Applicant: NSK Ltd., Shinagawa-ku, Tokyo (JP)

(72) Inventors: Yuki SHIMPO, Takasaki-shi, Gunma (JP); Atsushi SEKINO, Takasaki-shi, Gunma (JP)

(21) Appl. No.: 18/253,209

(22) PCT Filed: Oct. 28, 2021
(86) PCT No.: PCT/JP2021/039850

§ 371 Date: May 17, 2023

(30) Foreign Application Priority Data
Dec. 1, 2020 (JP) 2020-199802

(51) Int. Cl. F16C 33/54; F16C 19/30

(52) U.S. Cl. CPC F16C 33/54; F16C 19/305

(57) ABSTRACT

A thrust roller bearing includes a plurality of rollers, a cage, and a race. Each of a first member and a second member of the cage includes an annular web, an inner flange, and an outer flange. The inner flange of the first member and the inner flange of the second member are fixed to each other by crimping. A tab protruding in an axial direction is formed on the outer flange of the second member, and is inserted into one of a plurality of pockets of the first member. The race includes an annular portion forming a raceway surface, an outer race flange forming a first guide surface that guides the cage, and a guide portion forming a second guide surface that guides a shaft member.

### TECHNICAL FIELD

One aspect of the present disclosure relates to a thrust roller bearing.

### BACKGROUND ART

Patent Literature 1 discloses a thrust roller bearing in which a plurality of rollers are rollably retained by a cage. In the thrust roller bearing, the cage is formed of a pair of members, and a projection foinied on one of the pair of members is engaged with a pocket formed in the other. Accordingly, the pair of members are prevented from rotating around an axis relative to each other. Such a thrust roller bearing is incorporated into a transmission device of an automobile or the like and is used to support a rotating member. With a reduction in the size of a device, the thrust roller bearing is required to withstand a large thrust load and to adapt to the complex internal structure of the device.

### CITATION LIST

### Patent Literature

Patent Literature 1: Japanese Patent No. 3900843

### SUMMARY OF INVENTION

### Technical Problem

An object of one aspect of the present disclosure is to provide a thrust roller bearing that can increase the load capacity and that can enhance the degree of freedom of layout.

### Solution to Problem

According to one aspect of the present disclosure, there is provided a thrust roller bearing assemblable to a shaft member, the bearing including: a plurality of rollers; a cage rollably retaining the plurality of rollers; and a race including a raceway surface that comes into contact with the plurality of rollers. The cage includes a first member and a second member. Each of the first member and the second member includes a annular web formed with an annular shape and in which a plurality of pockets in which the plurality of rollers are disposed respectively, an inner flange extending from an inner edge of the web in an axial direction, and an outer flange extending from an outer edge of the web in the axial direction. The inner flange of the first member and the inner flange of the second member are fixed to each other by crimping. A tab protruding in the axial direction is for pied on the outer flange of the second member, and the tab is inserted into one of the plurality of pockets of the first member. The race includes an annular portion forming the raceway surface, an outer race flange extending from an outer edge of the annular portion in the axial direction, and forming a first guide surface that guides the cage, and a guide portion extending from the annular portion to protrude inward in a radial direction with respect to the cage, and forming a second guide surface that guides the shaft member.

In the thrust roller bearing, the tab protruding in the axial direction is formed on the outer flange of the second member, and the tab is inserted into the pocket formed in the first member. Accordingly, the relative rotation around an axis of the first member and the second member can be suppressed. In addition, since the tab is formed on the outer flange of the second member, compared to the case where a tab is formed on the inner flange of the second member, the strength of the cage can be increased and the load capacity can be increased. Further, in the thrust roller bearing, the inner flange of the first member and the inner flange of the second member are fixed to each other by crimping, and the cage is guided by the first guide surface of the outer race flange on a radially outer side. Accordingly, the height of the outer race flange can be lowered and the degree of freedom of layout can be enhanced. In addition, the race includes the guide portion extending from the annular portion to protrude inward in the radial direction with respect to the cage, and forming the second guide surface that guides the shaft member. Accordingly, the thrust roller bearing can be assembled to the shaft member on a radially inner side, and the degree of freedom of layout can be enhanced. Therefore, according to the thrust roller bearing, the load capacity can be increased and the degree of freedom of layout can be enhanced.

A height of the outer race flange from the annular portion may be lower than a height of the rollers in the axial direction. In this case, interference of the outer race flange can be suppressed and the degree of freedom of layout can be enhanced.

The guide portion may include an extending portion extending inward from the annular portion in the radial direction, and an inner race flange extending from an inner edge of the extending portion in the axial direction, and the second guide surface may be formed by an inner surface in the radial direction of the inner race flange. In this case, since it is not necessary to form a recessed portion for avoiding interference in the shaft member, processability can be improved. In addition, the shaft member can be thinned.

The guide portion may include an extending portion extending inward from the annular portion in the radial direction, and the second guide surface may be formed by a tip surface of the extending portion. In this case, the guide portion can be easily formed.

A protrusion amount of the second guide surface from the cage may be larger than a clearance between the race and the cage in the radial direction. In this case, the contact of the cage with the shaft member can be suppressed.

A height of the inner race flange from the annular portion may be lower than a height of the rollers in the axial direction. In this case, interference of the inner race flange can be suppressed and the degree of freedom of layout can be further enhanced.

A height of the inner race flange from the annular portion may be higher than a height of the rollers in the axial direction. In this case, the misalignment of an assembly direction with respect to the axial direction can be suppressed, and the inner race flange can be used as a guide portion during assembly.

The inner race flange may be formed such that a height of the inner race flange is partially lowered. In this case, a lubricant can be adequately supplied.

The outer race flange may be formed such that a height of the outer race flange is partially lowered. In this case, a lubricant can be adequately supplied.

### Advantageous Effects of Invention

According to one aspect of the present disclosure, it is possible to provide the thrust roller bearing that can increase the load capacity and that can enhance the degree of freedom of layout.

### BRIEF DESCRIPTION OF DRAWINGS

FIG. 1 is a plan view of a thrust roller bearing of an embodiment.

FIG. 2 is a cross-sectional view taken along line II-II in FIG. 1.

FIG. 3 is a cross-sectional view of a first member and a second member taken along line in FIG. 1.

FIG. 4 is a perspective view of the second member.

FIG. 5 is a perspective view illustrating a state where a tab is inserted into a pocket.

FIG. 6 is a cross-sectional view illustrating one example of an assembled state of the thrust roller bearing.

FIG. 7(a) is a cross-sectional view of a thrust roller bearing of a comparative example, and FIG. 7(b) is a cross-sectional view of the thrust roller bearing of the embodiment.

FIG. 8 is a cross-sectional view illustrating another example of the assembled state of the thrust roller bearing of the embodiment.

FIG. 9(a) is a cross-sectional view of a thrust roller bearing of a first modification example, and FIG. 9(b) is a cross-sectional view of a thrust roller bearing of a second modification example.

FIG. 10(a) is a cross-sectional view of a thrust roller bearing of a third modification example, and FIG. 10(b) is a cross-sectional view of a thrust roller bearing of a fourth modification example.

FIG. 11 is a plan view of the thrust roller bearing of the third modification example.

FIG. 12 is a plan view of the thrust roller bearing of the fourth modification example.

FIG. 13 is a cross-sectional view of a thrust roller bearing of a fifth modification example.

### DESCRIPTION OF EMBODIMENTS

Hereinafter, one embodiment of the present disclosure will be described in detail with reference to the drawings. In the following description, the same reference signs are used to denote the same or equivalent elements, and duplicate descriptions will be omitted.

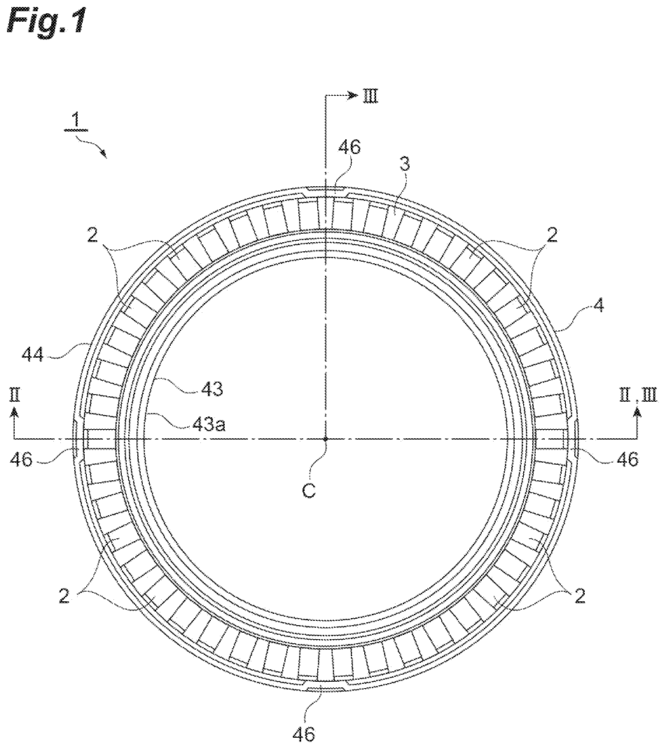

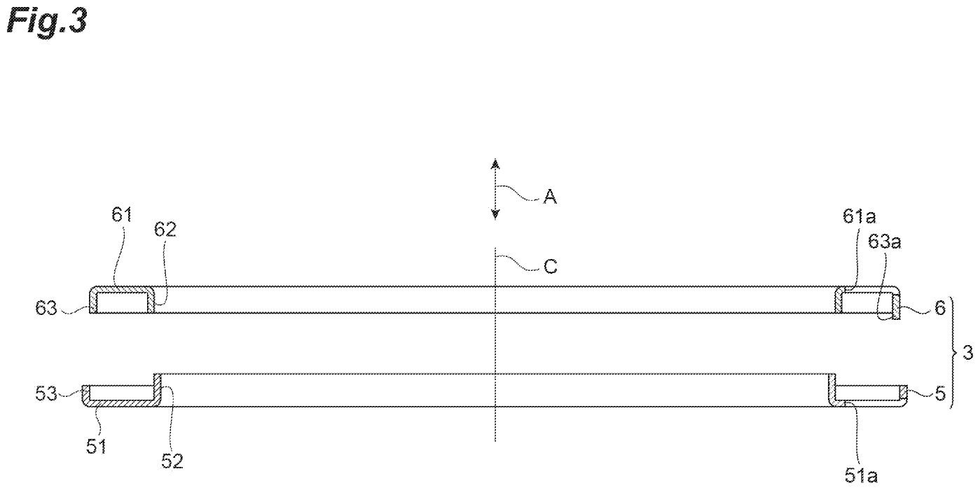

As illustrated in FIGS. 1, 2, and 3, a thrust roller bearing 1 includes a plurality of rollers 2, a cage (thrust cage) 3, and a race (raceway ring) 4. Each roller 2 is formed in, for example, a cylindrical shape. The plurality of rollers 2 are retained by the cage 3. The plurality of rollers 2 are arranged at equal intervals along a circumferential direction (radially) such that an extension line of a central axis of each roller 2 passes through a central axis (rotation axis) C of the thrust roller bearing 1. Accordingly, each roller 2 revolves (rolls) around the central axis C while rotating on a surface of the race 4. Incidentally, the rollers 2 are not limited to having a cylindrical shape, and can be formed in any shape such as a needle shape or a rod shape. Hereinafter, a direction parallel to the central axis C is referred to as an axial direction A, a direction perpendicular to the central axis C (direction radially extending from the central axis C) is referred to as a radial direction, and a direction around the central axis C is referred to as the circumferential direction.

The cage 3 includes a first member 5 and a second member 6. Each of the first member 5 and the second member 6 is formed, for example, by subjecting a metal sheet material to press machining, and has a substantially C-shaped (U-shaped) cross-sectional shape. The cage 3 is formed by fitting the first member 5 and the second member 6 to each other along the axial direction A.

The first member 5 includes a web 51, an inner flange 52, and an outer flange 53. The web 51 is formed in an annular flat plate shape, and extends along a plane perpendicular to the axial direction A (direction parallel to the central axis C). A plurality of pockets 51a in which the plurality of rollers 2 are disposed are formed in the web 51. Each pocket 51a is formed in, for example, a rectangular shape. The plurality of pockets 51a are disposed at equal intervals along the circumferential direction.

The inner flange 52 is formed in a substantially cylindrical shape, and extends from an inner edge of the web 51 in the axial direction A. The outer flange 53 is formed in a substantially cylindrical shape, and extends from an outer edge of the web 51 in the axial direction A. The inner flange 52 and the outer flange 53 protrude from the web 51 to the same side in the axial direction A, and extend perpendicularly to the web 51. The inner flange 52 is formed higher than the outer flange 53.

The second member 6 includes a web 61, an inner flange 62, and an outer flange 63. The web 61 is formed in an annular flat plate shape, and extends along a plane perpendicular to the axial direction A. A plurality of pockets 61a in which the plurality of rollers 2 are disposed are formed in the web 61. Each pocket 61a is formed in, for example, the same shape as that of the pockets 51a. The plurality of pockets 61a are disposed at equal intervals along the circumferential direction.

The inner flange 62 is formed in a substantially cylindrical shape, and extends from an inner edge of the web 61 in the axial direction A. The outer flange 63 is formed in a substantially cylindrical shape, and extends from an outer edge of the web 61 in the axial direction A. The inner flange 62 and the outer flange 63 protrude from the web 61 to the same side in the axial direction A, and extend perpendicularly to the web 61.

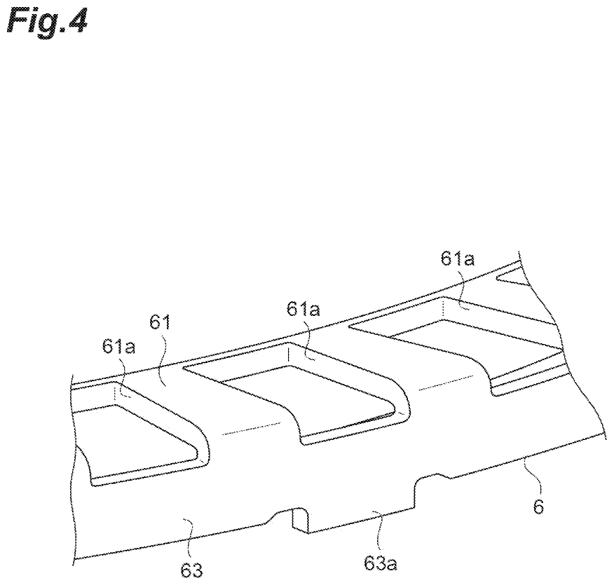

As particularly illustrated in FIG. 4, a tab (locking tab) 63a protruding in the axial direction A is formed on the outer flange 63. The tab 63 a is formed in, for example, a rectangular plate shape, and protrudes in the axial direction A with respect to portions of the outer flange 63 other than the tab 63a. In this example, a plurality of the tabs 63a are provided; however, it is enough if one or more tabs 63a are provided.

The first member 5 and the second member 6 are fixed to each other in a state where the second member 6 is disposed inside the first member 5. In the fixed state, the inner flange 52 of the first member 5 is located inside (on a side toward the central axis C) the inner flange 62 of the second member 6 in the radial direction, and is in contact with the inner flange 62. The outer flange 53 of the first member 5 is located outside (on a side away from the central axis C) the outer flange 63 of the second member 6 in the radial direction, and is in contact with the outer flange 63. The web 51 and the web 61 face each other in the axial direction A in a state where the web 51 and the web 61 are apart from each other.

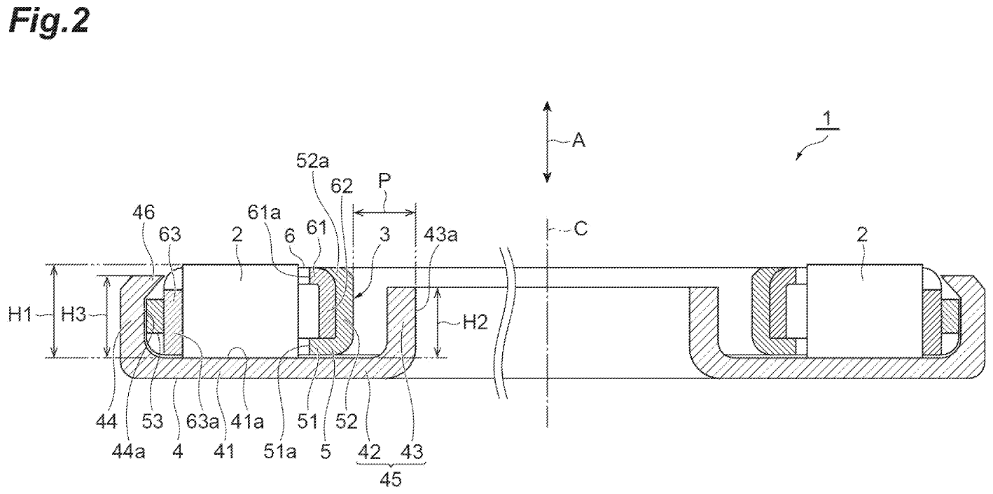

The inner flange 52 of the first member 5 and the inner flange 62 of the second member 6 are fixed to each other by crimping. More specifically, the inner flange 52 is crimped such that a crimped portion 52a deformed toward a base end portion of the inner flange 62 (outward in the radial direction) is formed at a tip end portion of the inner flange 52 (FIG. 2), and accordingly, the first member 5 and the second member 6 are fixed to each other so as not to separate from each other in the axial direction A. A part of the crimped portion 52a overlaps the base end portion of the inner flange 62 as viewed in the axial direction A.

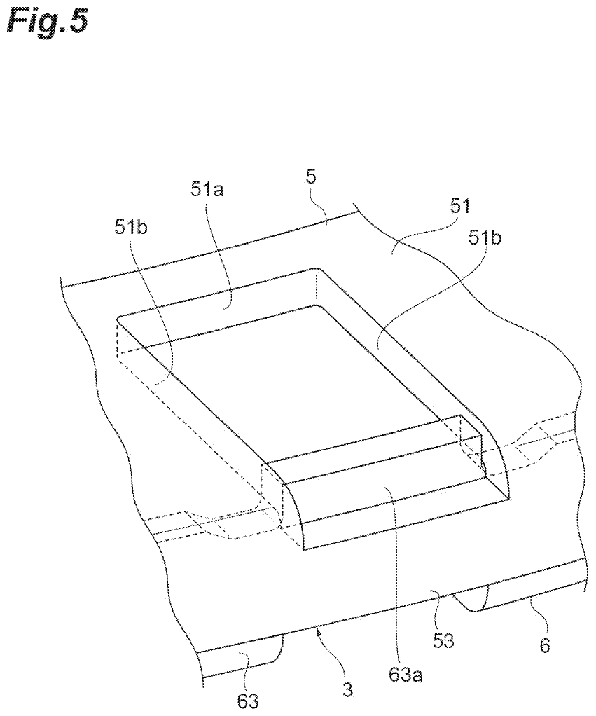

As particularly illustrated in FIG. 5, in the state where the first member 5 and the second member 6 are fixed, the tab 63a of the second member 6 is inserted into the pocket 51a of the first member 5. The tab 63a is inserted into an outer portion in the radial direction of the pocket 51a, and engages with an inner surface 51b of the pocket 51a in the radial direction. The tab 63a is disposed in contact with the inner surface 51b or with a slight clearance between the tab 63a and the inner surface 51b, and regulates the relative rotation around an axis of the first member 5 and the second member 6 by contacting the inner surface 51b. Due to the engagement between the tab 63a and the pocket 51a, the pocket 51a of the first member 5 and the pocket 61a of the second member 6 are disposed at positions aligned with each other in the circumferential direction.

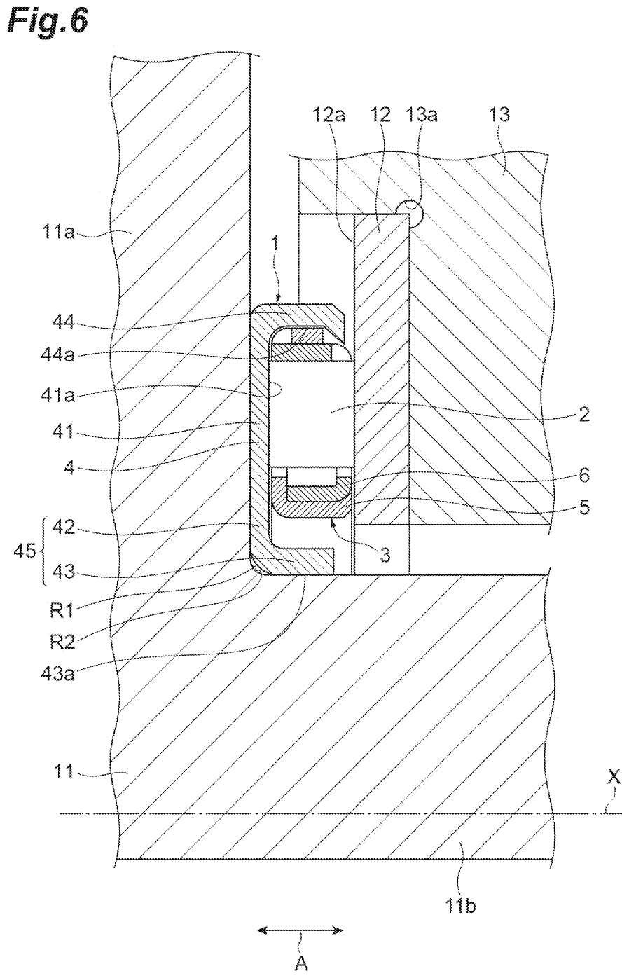

Each roller 2 is disposed and rollably retained in a space defined by the first member 5 and the second member 6. The roller 2 protrudes from the pocket 51a on one side in the axial direction A, and protrudes from the pocket 61a on the other side in the axial direction A. Namely, a height of the cage in the axial direction A is lower than a height (roller diameter) H1 of the roller 2 in the axial direction A. The roller 2 rolls on a raceway surface 41a of the race 4 to be described later on the one side in the axial direction A, and rolls on a raceway surface 12a of a race member 12 to be described later on the other side in the axial direction A (FIG. 6).

The race 4 is formed, for example, by subjecting a metal sheet material to press machining, and has a substantially C-shaped (U-shaped) cross-sectional shape. The race 4 includes an annular portion 41, an extending portion 42, an inner race flange 43, and an outer race flange 44. The annular portion 41 is formed in an annular flat plate shape, and extends along a plane perpendicular to the axial direction A. One surface of the annular portion 41 forms the raceway surface 41a that comes into contact with the plurality of rollers 2.

The extending portion 42 extends inward from the annular portion 41 in the radial direction. The extending portion 42 is formed in an annular flat plate shape, and is located on the same plane as the annular portion 41. The inner race flange 43 is formed in a substantially cylindrical shape, and extends from an inner edge of the extending portion 42 in the axial direction A. An inner surface (inner peripheral surface) in the radial direction of the inner race flange 43 forms a second guide surface 43a that guides a shaft member 11 to be described later. In other words, the extending portion 42 and the inner race flange 43 form a guide portion 45 that provides the second guide surface 43a. The guide portion 45 extends from the annular portion 41, and protrudes inward in the radial direction with respect to the cage 3.

The outer race flange 44 is formed in a substantially cylindrical shape, and extends from an outer edge of the annular portion 41 in the axial direction A. An inner surface (inner peripheral surface) in the radial direction of the outer race flange 44 forms a first guide surface 44a that guides the cage 3. The inner race flange 43 and the outer race flange 44 protrude from the annular portion 41 or the extending portion 42 to the same side (cage 3 side) in the axial direction A, and extend perpendicularly to the annular portion 41 and the extending portion 42.

The cage 3 is fitted to the race 4 by clearance fitting. More specifically, the cage 3 is fitted to an inner side of the race 4 with a slight clearance between an outer peripheral surface of the outer flange 53 of the first member 5 and the inner peripheral surface (first guide surface 44a) of the outer race flange 44. In this state, the roller 2 retained by the cage 3 comes into contact with the raceway surface 41a of the race 4. A protrusion amount P of the second guide surface 43a from the cage 3 is larger than the above-mentioned clearance (clearance between the race 4 and the cage 3 in the radial direction). In addition, a clearance between an inner peripheral surface of the inner flange 52 of the first member 5 and an outer peripheral surface of the inner race flange 43 in the radial direction is larger than the above-mentioned clearance (clearance between the outer peripheral surface of the outer flange 53 and the inner peripheral surface of the outer race flange 44 in the radial direction). For this reason, even when the cage 3 is displaced relative to the race 4 in the radial direction, the cage 3 does not come into contact with the inner race flange 43 of the race 4.

A plurality (four in this example) of locking portions 46 are formed on the outer race flange 44. Each locking portion 46 is formed in a tab shape by deforming a tip portion of the outer race flange 44 inward in the radial direction in a state where the cage 3 is assembled in the race 4. The plurality of locking portions 46 are, for example, disposed at equal intervals along the circumferential direction. The locking portions 46 prevent detachment of the cage 3 from the race 4. In this example, the four locking portions 46 are provided; however, it is enough if two or more locking portions 46 are provided. Alternatively, one locking portion 46 may be provided. In this case, the locking portion 46 may be formed (curled) to extend over the entire circumference of the outer race flange 44.

A height H2 of the inner race flange 43 from the annular portion 41 is lower than the height H1 of the rollers 2 in the axial direction A. A height H3 of the outer race flange 44 from the annular portion 41 is lower than the height H1 of the rollers 2 in the axial direction A. In other words, the inner race flange 43 and the outer race flange 44 do not protrude from the rollers 2 in the axial direction A.

FIG. 6 is a cross-sectional view illustrating one example of an assembled state of the thrust roller bearing 1. As illustrated in FIG. 6, the thrust roller bearing 1 can be assembled to the shaft member 11 (for example, a rotating shaft). The shaft member 11 rotates around a rotation axis X. In the example of FIG. 6, the thrust roller bearing 1 is assembled between the shaft member 11 and the race member 12. The race member 12 is an annular plate-shaped member and is supported by a member 13 (for example, a housing or gear). The race member 12 has a surface forming the raceway surface 12a that comes into contact with the plurality of rollers 2. A recessed portion 13a for avoiding interference with the race member 12 is formed in the member 13. The thrust roller bearing 1 supports the shaft member 11 and the member 13 so as to be rotatable relative to each other, while supporting a thrust load (load in the axial direction A).

The shaft member 11 includes a first portion 11a and a second portion 11b extending from the first portion 11a in the axial direction. The race 4 is fitted to the shaft member 11 by clearance fitting. More specifically, in a state where the annular portion 41 faces and abuts the first portion 11a and a slight clearance is set between the inner peripheral surface (second guide surface 43a) of the inner race flange 43 and the second portion 11b, the race 4 is fitted to an outer side (outer peripheral surface) in the radial direction of the second portion 11b. In this state, the second guide surface 43a guides the second portion 11b, and functions as a guide surface for positioning the race 4 in the radial direction with respect to the shaft member 11.

### Functions and Effects

In the thrust roller bearing 1, as illustrated in FIG. 5, the tab 63a protruding in the axial direction A is formed on the outer flange 63 of the second member 6, and the tab 63a is inserted into the pocket 51a formed in the first member 5. Accordingly, the relative rotation around the axis of the first member 5 and the second member 6 can be suppressed. In addition, since the tabs 63a are formed on the outer flange 63 of the second member 6, compared to the case where tabs are formed on the inner flange 62 of the second member 6, the strength of the cage 3 can be increased and the load capacity can be increased. The reason for this is that in the case where the tabs are formed on the inner flange 62, there is a concern that the width of a pillar portion (portion between the adjacent pockets 51a or between the adjacent pockets 61a) of the cage 3 with which the inserted tab engages is narrowed on a radially inner side of the cage 3, while in the case where the tabs 63a are formed on the outer flange 63, such a situation can be suppressed. Such a configuration in which the tabs 63a are provided on a radially outer side is particularly effective when the required load capacity is large, the diameter of the rollers 2 is large, and the number of the rollers 2 is large.

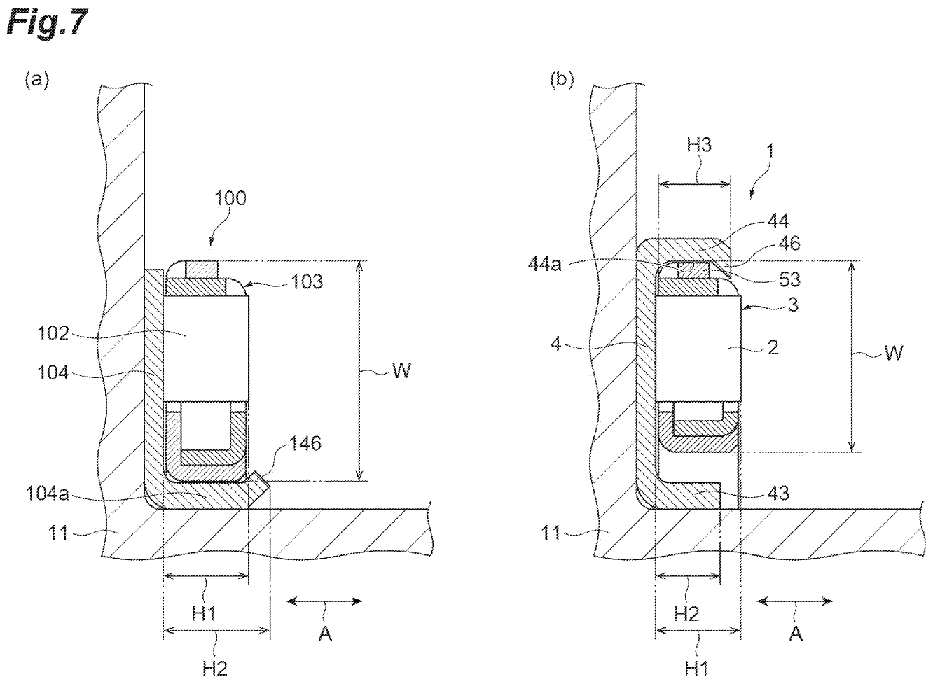

Further, in the thrust roller bearing 1, the inner flange 52 of the first member 5 and the inner flange 62 of the second member 6 are fixed to each other by crimping, and the cage 3 is guided by the first guide surface 44a of the outer race flange 44 on the radially outer side. Accordingly, the height H3 of the outer race flange 44 can be lowered and the degree of freedom of layout can be enhanced. This point will be further described with reference to FIG. 7.

FIG. 7(a) is a cross-sectional view of a thrust roller bearing 100 of a comparative example, and FIG. 7(b) is a cross-sectional view of the thrust roller bearing 1 of the embodiment. As illustrated in FIG. 7(a), in the thrust roller bearing 100 of the comparative example, rollers 102 are retained by a cage 103, and the cage 103 is assembled to a race 104. The cage 103 is guided by an outer peripheral surface of an inner race flange 104a on the radially inner side.

In the thrust roller bearing 100 of the comparative example, since it is necessary to form a locking portion 146 on the inner race flange 104a and to make the locking portion 146 further protrude in the axial direction A than the crimped portion of the cage 103, so as to lock the cage 103, the height H2 of the inner race flange 104a becomes higher than the height H1 of the rollers 102. In this case, depending on the layout of surrounding components, the inner race flange 104a may interfere with the surrounding components, so that it may not be possible to dispose the thrust roller bearing 100.

In contrast, as described above, as illustrated in FIG. 7(b), in the thrust roller bearing 1 of the embodiment, the cage 3 is guided by the first guide surface 44a of the outer race flange 44 on the radially outer side, and the locking portions 46 engage with the outer flange 53 of the cage 3. Accordingly, the height H3 of the outer race flange 44 can be lower than the H1 of the rollers 2, and the degree of freedom of layout can be enhanced.

In addition, in the case of configuring the thrust roller bearing 100 of the comparative example such that the thrust roller bearing 100 can be assembled between the shaft member 11 and the race member 12 as illustrated in FIG. 6, since it is necessary to extend an inner portion in the radial direction of the cage 103 to the outer peripheral surface of the inner race flange 104a which is a guide surface for the cage 103, as illustrated in FIG. 7(a), it is necessary to widen a width W in the radial direction of the cage 3. In contrast, as illustrated in FIG. 7(b), in the thrust roller bearing 1 of the embodiment, the width W of the cage 3 can be narrower than in the comparative example. As a result, the processability of the cage 3 can be improved and cost reduction can be achieved. In addition, the weight can also be reduced.

In addition, as illustrated in FIG. 6, the race 4 includes the guide portion 45 extending from the annular portion 41 to protrude inward in the radial direction with respect to the cage 3, and forming the second guide surface 43a that guides the shaft member 11. Accordingly, the thrust roller bearing 1 can be assembled to the shaft member 11 on the radially inner side, and the degree of freedom of layout can be enhanced. As described above, according to the thrust roller bearing 1, the load capacity can be increased and the degree of freedom of layout can be enhanced.

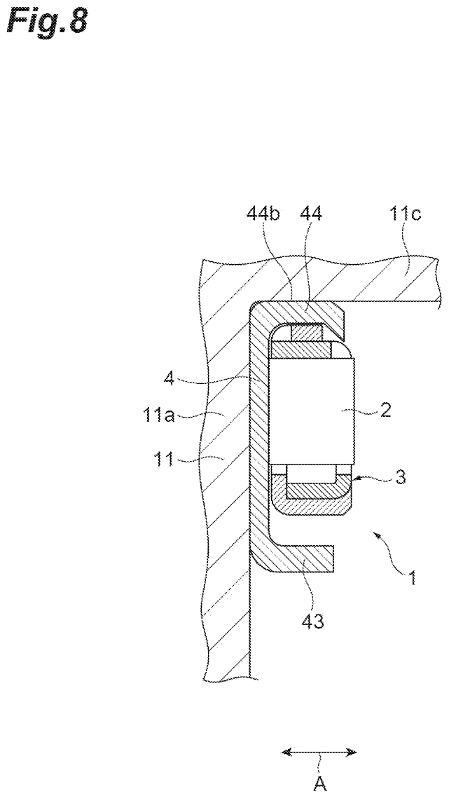

As illustrated in FIG. 6, the thrust roller bearing 1 can be assembled to the outer side of the second portion 11b such that the second portion 11b of the shaft member 11 is guided by the second guide surface 43a on the radially inner side (inner-side guide). In addition, as illustrated in FIG. 8, the thrust roller bearing 1 can be assembled to an inner side of an outer portion 11c of the shaft member 11 such that the outer portion 11c is guided by a third guide surface 44b on the radially outer side (outer-side guide). The third guide surface 44b is formed by an outer surface (outer peripheral surface) in the radial direction of the outer race flange 44. The outer portion 11c is a portion extending from the first portion 11a in the axial direction. In such a manner, the thrust roller bearing 1 can be used for both layouts including inner-side guide and outer-side guide.

When a thrust roller bearing in which unlike the thrust roller bearing 1 of the embodiment, the guide portion 45 is not provided and the race does not protrude inward in the radial direction with respect to the cage is used for inner-side guide in which the cage is directly guided by the outer peripheral surface of the shaft member 11, there is a concern that the cage is sandwiched between the race and the shaft member and a stress acts to cause damage to the cage 3. In contrast, in the thrust roller bearing 1 of the embodiment, such a situation can be suppressed.

In addition, in the thrust roller bearing 1, the height H3 of the outer race flange 44 from the annular portion 41 is lower than the height H1 of the rollers 2 in the axial direction A. Accordingly, interference of the outer race flange 44 can be suppressed and the degree of freedom of layout can be enhanced.

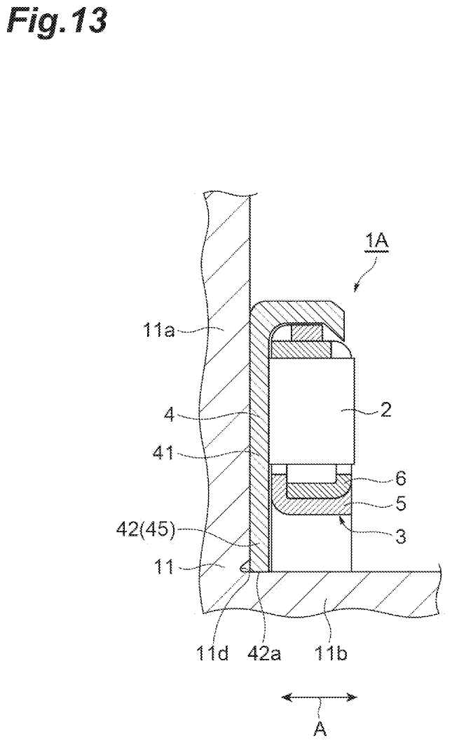

The guide portion 45 includes the extending portion 42 extending inward from the annular portion 41 in the radial direction, and the inner race flange 43 extending from the inner edge of the extending portion 42 in the axial direction A, and the second guide surface 43a is formed of the inner surface in the radial direction of the inner race flange 43. Accordingly, since it is not necessary to form a recessed portion for avoiding interference in the shaft member 11, processability can be improved. In addition, the shaft member 11 can be thinned. Namely, the extending portion 42 and the inner race flange 43 are formed by bending a metal sheet material, and a curved surface having a curvature radius R1 and being continuous with the second guide surface 43a is formed at a boundary portion between the extending portion 42 and the inner race flange 43 (FIG. 6). The formation of a recessed portion 11d (FIG. 13) for preventing interference in the shaft member 11 can be omitted by reducing a curvature radius R2 of a boundary portion (corner portion) between the first portion 11a and the second portion 11b of the shaft member 11 to be smaller than the curvature radius R1.

The protrusion amount P of the second guide surface 43a from the cage 3 is larger than the clearance between the race 4 and the cage 3 in the radial direction. Accordingly, the contact of the cage 3 with the shaft member 11 can be suppressed.

The height H2 of the inner race flange 43 from the annular portion 41 is lower than the height H1 of the rollers 2 in the axial direction A. Accordingly, interference of the inner race flange 43 can be suppressed and the degree of freedom of layout can be further enhanced.

The thrust roller bearing is a bearing that rotatably supports a thrust load (axial load and shaft load) acting on a rotating shaft, and is mainly applied to a gear side of an automobile transmission. In the transmission, a helical gear for noise reduction can be used. The thrust roller bearing is provided on the gear side that is a side surface of the helical gear, and supports a thrust load acting on the helical gear. The magnitude of the thrust load acting on the gear side can significantly change. For example, the helical gear is changed between a selection state and a non-selection state by a shifting operation during traveling of the automobile. As a result, the thrust roller bearing repeatedly changes between thrust load ON and OFF (load and no-load) states or rotation and non-rotation (rotation together with the rotating shaft) states. In addition, during shifting, in addition to a pure thrust load, complex loads may also act, and the race and rollers may momentarily become a non-contact state (clearance occurs). When the thrust roller bearing is used for such an application, some of the loads act on the cage. In this regard, in the thrust roller bearing 1 of the embodiment, two members, the first member 5 and the second member 6, are combined to form a robust cage, and the tabs 63a prevent the two members from rotating relative to each other.

In the cage disclosed in Patent Literature 1 (Japanese Patent No. 3900843) described above, locking tabs are provided on a radially inner side. In contrast, in the cage 3 of the thrust roller bearing 1 of the embodiment, the locking tabs (tabs 63a) are provided on the radially outer side. For this reason, the width of the pillar portion of the cage 3 in the circumferential direction can be widened, and the relative rotation of the first member 5 and the second member 6 forming the cage 3 can be effectively suppressed. In addition, in the configuration disclosed in Patent Literature 1, since small windows are provided continuously with the pockets, the radial dimension of the cage is increased, while in the thrust roller bearing 1 of the embodiment, since small windows are not provided, the size of the cage 3 can be reduced by reducing the radial dimension of the cage 3 or the load capacity can be increased by lengthening the rollers 2.

The thrust roller bearing of Patent Literature 1 is a bearing called a cage-and-roller formed of only the cage and the rollers, and does not include a race. In the case of the cage-and-roller, for example, a race equivalent portion is created on a gear side of a helical gear by cutting, and a member that regulates the position in the radial direction of the cage-and-roller does not exist on a bearing side. For this reason, when the cage-and-roller is significantly eccentric, there is a possibility that an overhang occurs in which the rollers deviate outward from the race in the radial direction.

In this regard, in the thrust roller bearing 1 of the embodiment, the race 4 is combined with only one side of the cage 3. Then, the cage 3 is guided by the inner peripheral surface (first guide surface 44a) of the outer race flange 44, and is positioned in the radial direction with respect to a mating member by the inner surface (second guide surface 43a) of the inner race flange 43. Accordingly, a significant eccentricity of the cage 3 with respect to the mating member can be suppressed, and the occurrence of an overhang can be suppressed. As described above, according to the thrust roller bearing 1 of the embodiment, even in the case where the locking tabs are provided on the cage for use in a severe thrust load environment, the occurrence of an overhang can be suppressed while reducing the radial dimension of the cage, and the degree of freedom of layout can be enhanced by suppressing interference of the locking portions of the race with a mating race.

### Modification Examples

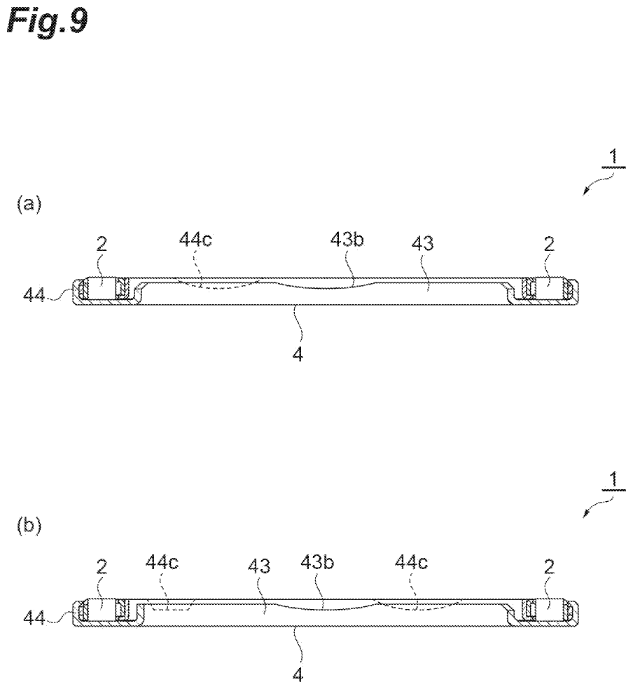

In the thrust roller bearing 1 of a first modification example illustrated in FIG. 9(a), the inner race flange 43 is formed such that the height of the inner race flange 43 is partially lowered. Specifically, a notch (scallop) 43b is formed on the inner race flange 43, and the height of the inner race flange 43 is lowered at a location where the notch 43b is formed. The notch 43b is formed in a substantially semi-elliptical shape as viewed in the radial direction.

In addition, in the first modification example, the outer race flange 44 is formed such that the height of the outer race flange 44 is partially lowered. Specifically, a notch (scallop) 44c is formed on the outer race flange 44, and the height of the outer race flange 44 is lowered at a location where the notch 44c is formed. The notch 44c is formed in a substantially semi-elliptical shape as viewed in the radial direction.

With the first modification example, similarly to the embodiment, the load capacity can be increased and the degree of freedom of layout can be enhanced. In addition, since the height of the inner race flange 43 is partially lowered, the inner race flange 43 can be prevented from overlapping, for example, a lubrication hole for supplying a lubricant, and the lubricant can be adequately supplied. In addition, since the height of the outer race flange 44 is partially lowered, the outer race flange 44 can be prevented from overlapping, for example, a lubrication hole for discharging the lubricant, and the lubricant can be adequately discharged. Incidentally, the notches 43b and 44c can be formed in any shape such as a rectangular shape or a semicircular shape. For example, in the thrust roller bearing 1 of a second modification example illustrated in FIG. 9(b), the notch 44c is formed in a trapezoidal shape. The depths of the notches 43b and 44c may be set to any depth.

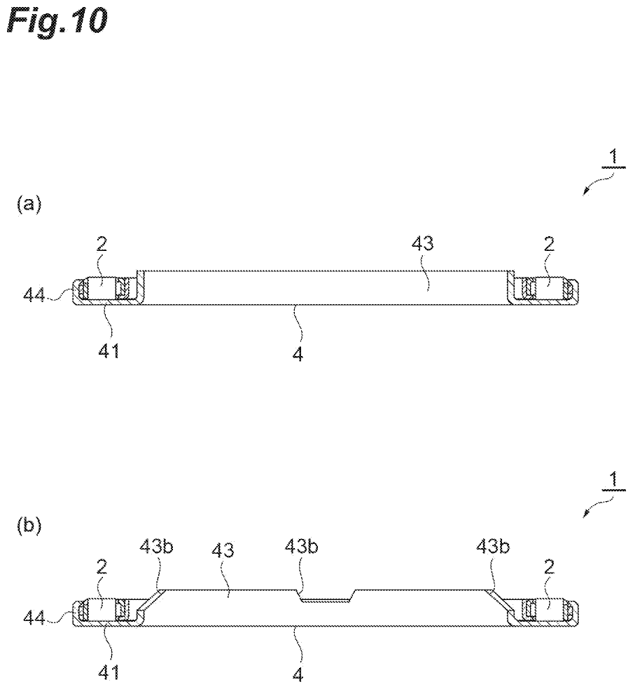

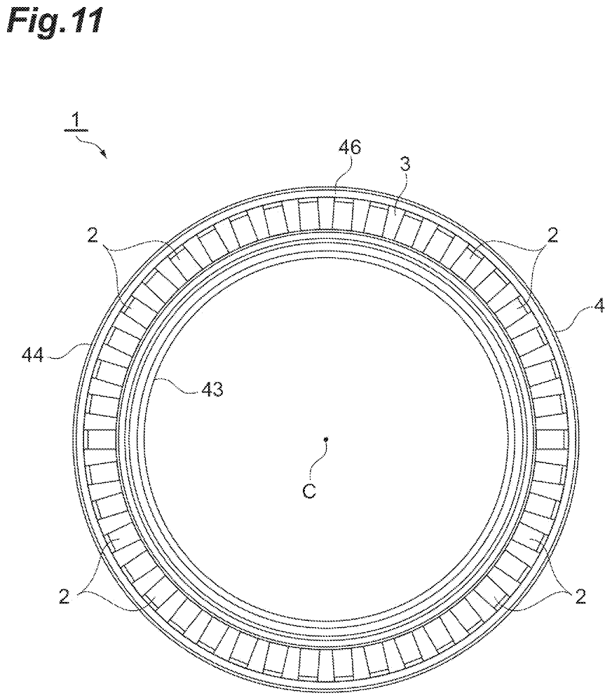

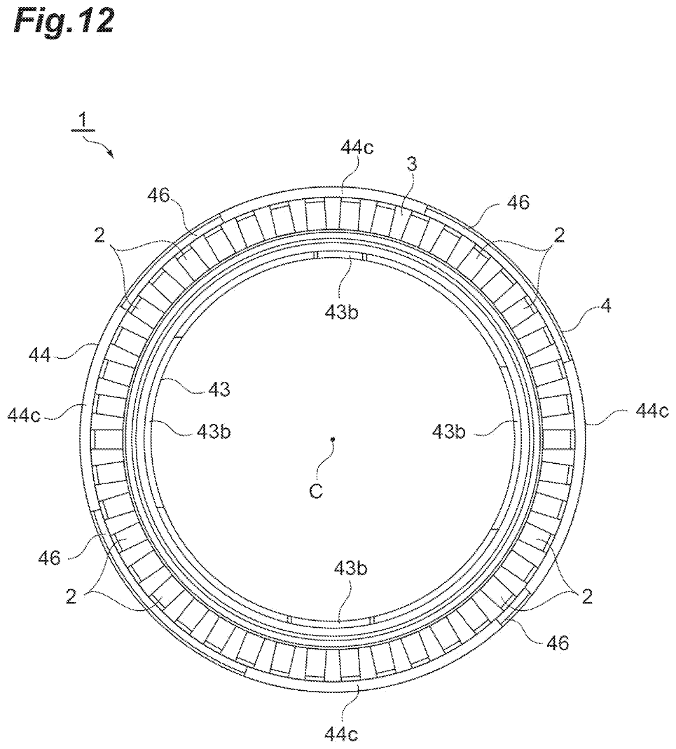

In the thrust roller bearing 1 of a third modification example illustrated in FIGS. 10(a) and 11 and in the thrust roller bearing 1 of a fourth modification example illustrated in FIGS. 10(b) and 12, the height of the inner race flange 43 from the annular portion 41 is higher than the height of the rollers 2 in the axial direction A. As illustrated in FIG. 11, in the third modification example, the locking portion 46 is formed (curled) to extend over the entire circumference of the outer race flange 44. In the fourth modification example, the notch 43b is formed on the inner race flange 43. In addition, in the fourth modification example, similarly to the first modification example, a plurality of the notches (scallops) 44c are formed on the outer race flange 44. Then, a plurality of the locking portions 46 (partial curls) are formed on portions of the outer race flange 44, on which the notches 44c are not formed. In the fourth modification example, the length (circular arc length) of the locking portions 46 in the circumferential direction is 6 mm or more, preferably 12 mm or more. With the third and fourth modification examples, similarly to the embodiment, the load capacity can be increased and the degree of freedom of layout can be enhanced. In addition, since the height of the inner race flange 43 is higher than the height of the rollers 2, the misalignment of an assembly direction with respect to the axial direction A can be suppressed, and the inner race flange 43 can be used as a guide portion during assembly. In addition, in the third modification example, since the locking portion 46 is formed to extend over the entire circumference of the outer race flange 44, the strength of the locking portion 46 can be increased. In addition, in the fourth modification example, the inner race flange 43 can be prevented from overlapping the lubrication hole for supplying the lubricant, and the lubricant can be adequately supplied.

In a thrust roller bearing 1A of a fifth modification example illustrated in FIG. 13, the guide portion 45 is formed of only the extending portion 42. A second guide surface 42a that guides the shaft member 11 is formed of a tip surface (inner edge) of the extending portion 42. The recessed portion 11d for avoiding interference with a tip (inner end portion in the radial direction) of the extending portion 42 is formed at the boundary portion (corner) between the first portion 11a and the second portion 11b of the shaft member 11.

With the fifth modification example, similarly to the embodiment, the load capacity can be increased and the degree of freedom of layout can be enhanced. In addition, since the guide portion 45 is formed of only the extending portion 42, the guide portion 45 can be easily formed. In addition, the recessed portion 11d for avoiding interference with the tip of the extending portion 42 is formed in the shaft member 11. Accordingly, the contact of the extending portion 42 with the shaft member 11 can be suppressed. In addition, the extending portion 42 (race 4) can be fitted to the shaft member 11 with high accuracy. In addition, a protrusion amount by which the tip surface of the extending portion 42 protrudes from the cage 3 in the radial direction is set to be equal to the protrusion amount P of the second guide surface 43a from the cage 3 in the embodiment, and is larger than the clearance between the race 4 and the cage 3 in the radial direction. Accordingly, the contact of the cage 3 with the shaft member 11 can be suppressed.

The present disclosure is not limited to the embodiment and the modification examples. For example, the material and the shape of each configuration are not limited to the material and the shape described above, and various materials and shapes can be adopted.

### REFERENCE SIGNS LIST

1, 1A: thrust roller bearing, 3: cage, 4: race, 5: first member, 6: second member, 11: shaft member, 41: annular portion, 41a: raceway surface, 42: extending portion, 42a, 43a: second guide surface, 43: inner race flange, 44: outer race flange, 44a: first guide surface, 45: guide portion, 51, 61: web, 51a, 61a: pocket, 52, 62: inner flange, 53, 63: outer flange, 63a: tab, A: axial direction, P: protrusion amount, H1: height of roller, H2: height of inner race flange, H3: height of outer race flange.

1. A thrust roller bearing assemblable to a shaft member, the bearing comprising:
a plurality of rollers;
a cage rollably retaining the plurality of rollers; and
a race including a raceway surface that comes into contact with the plurality of rollers,
wherein the cage includes a first member and a second member,
wherein each of the first member and the second member includes an annular web formed with a plurality of pockets in which the plurality of rollers are disposed respectively, an inner flange extending from an inner edge of the web in an axial direction, and an outer flange extending from an outer edge of the web in the axial direction,
wherein the inner flange of the first member and the inner flange of the second member are fixed to each other by crimping,
wherein a tab protruding in the axial direction is formed on the outer flange of the second member, and the tab is inserted into one of the plurality of pockets of the first member, and
wherein the race includes an annular portion forming the raceway surface, an outer race flange extending from an outer edge of the annular portion in the axial direction, and forming a first guide surface that guides the cage, and a guide portion extending from the annular portion to protrude inward in a radial direction with respect to the cage, and forming a second guide surface for guiding the shaft member.

2. The thrust roller bearing according to claim 1, wherein a height of the outer race flange from the annular portion is lower than a height of the rollers in the axial direction.

3. The thrust roller bearing according to claim 1,
wherein the guide portion includes an extending portion extending inward from the annular portion in the radial direction, and an inner race flange extending from an inner edge of the extending portion in the axial direction, and
wherein the second guide surface is formed by an inner surface in the radial direction of the inner race flange.

4. The thrust roller bearing according to claim 1,
wherein the guide portion includes an extending portion extending inward from the annular portion in the radial direction, and
wherein the second guide surface is formed by a tip surface of the extending portion.

5. The thrust roller bearing according to claim 1, wherein a protrusion amount of the second guide surface from the cage is larger than a clearance between the race and the cage in the radial direction.

6. The thrust roller bearing according to claim 3, wherein a height of the inner race flange from the annular portion is lower than a height of the rollers in the axial direction.

7. The thrust roller bearing according to claim 3, wherein a height of the inner race flange from the annular portion is higher than a height of the rollers in the axial direction.

8. The thrust roller bearing according to claim 3, wherein the inner race flange is formed such that a height of the inner race flange is partially lowered.

9. The thrust roller bearing according to claim 1, wherein the outer race flange is formed such that a height of the outer race flange is partially lowered.

10. A thrust roller bearing comprising:
a plurality of rollers; and
a cage rollably retaining the plurality of rollers,
wherein the cage includes a first member and a second member,
wherein each of the first member and the second member includes an annular web formed with a plurality of pockets in which the plurality of rollers are disposed respectively, an inner flange extending from an inner edge of the web in an axial direction, and an outer flange extending from an outer edge of the web in the axial direction,
wherein the inner flange of the first member and the inner flange of the second member are fixed to each other by crimping, and
wherein a tab protruding in the axial direction is formed on the outer flange of the second member, and the tab is inserted into one of the plurality of pockets of the first member.

11. The thrust roller bearing according to claim 10, further comprising a race including an annular portion forming a raceway surface that comes into contact with the plurality of rollers.

12. The thrust roller bearing according to claim 11, wherein the race further includes an outer race flange extending from an outer edge of the annular portion in the axial direction.

13. The thrust roller bearing according to claim 12, wherein the outer race flange forms a guide surface for guiding the cage

14. The thrust roller bearing according to claim 13, wherein a height of the outer race flange from the annular portion is lower than a height of the rollers in the axial direction.

15. The thrust roller bearing according to claim 12, wherein the race further includes a guide portion extending from the annular portion to protrude inward in a radial direction with respect to the cage.

16. The thrust roller bearing according to claim 15,
wherein the outer race flange forms a first guide surface for guiding the cage,
wherein the bearing is configured to support a shaft member, and
wherein the guide portion forms a second guide surface for guiding the shaft member.

17. The thrust roller bearing according to claim 11,
wherein the bearing is configured to support a shaft member,
wherein the race further includes a guide portion extending from the annular portion to protrude inward in a radial direction with respect to the cage, and
wherein the guide portion forms a guide surface for guiding the shaft member.

18. The thrust roller bearing according to claim 17, further comprising an inner race flange extending from an inner edge of the guide portion in the axial direction,
wherein an inner surface of the inner race flange in the radial direction forms the guide surface for guiding the shaft member.

19. The thrust roller bearing according to claim 18, wherein a height of the inner race flange from the annular portion is lower than a height of the rollers in the axial direction.

20. The thrust roller bearing according to claim 18, wherein a height of the inner race flange from the annular portion is higher than a height of the rollers in the axial direction.
